(19) United States
(12) Patent Application Publication
(10) Pub. No.: US 2007/0008984 A1
(43) Pub. Date: Jan. 11, 2007

(54) Buffer management system, digital audio receiver, headphones, loudspeaker, method of buffer management

(75) Inventors: Norbert Jeanne Louis Philips, Leuven (BE); Koen Willem Derom, Leuven (BE); Eric Vos, Leuven (BE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/567,206

(22) PCT Filed: Jul. 28, 2004
(86) PCT No.: PCT/IB04/51309

§ 371 Date: Feb. 3, 2006

(30) Foreign Application Priority Data
Aug. 5, 2003 (EP) 03102434.2

(51) Int. Cl. H04L 12/56

(52) U.S. Cl. 370/412; 370/230

(57) ABSTRACT

The buffer management system (100) is arranged to control in a data communication system an end to end delay (Δ) of a data unit (150) from input to output. Blocks (104, 106) of data units (150, 152) are written in a buffer (102) with a block write rate (Rw), and data units (154, 156) are read from this buffer (102) with a read rate (Rr). The end to end delay (Δ) is controlled by adapting the read rate (Rr) from the buffer (102), and hence the buffer filling (F) on the basis of measurements of delays in the buffer management system (100). For the calculation of the read rate (Rr) at least an input time measurement (mTa) of an input time instant (Ta) of input of the data unit (150) in the buffer management system (100) is required

The invention relates to a buffer management system for controlling in a data communication system a delay of a data unit between input in the buffer management system and output from the buffer management system, comprising:

a buffer, in which blocks of inputted data units are written with a block write rate, and from which data units are read with a read rate;

a buffer filling measurement component arranged to determine an amount of data units in the buffer at a specified time instant, and yielding a filling measurement; and

a data rate conversion component, arranged to set a ratio of the read rate and the write rate, on the basis of the filling measurement.

The invention also relates to a digital audio receiver comprising a radio receiver component with an output connected to such a buffer management system.

The invention also relates to headphones comprising such a digital audio receiver, an output of the digital audio receiver being connected to a loudspeaker of the headphones.

The invention also relates to a stand-alone surround sound loudspeaker cabinet comprising such a digital audio receiver, an output of the digital audio receiver being connected to a loudspeaker in the cabinet.

The invention also relates to a method of controlling in a data communication system a delay of a data unit, between input in a digital audio receiver and output from the digital audio receiver, comprising:

Writing blocks of inputted data units in a buffer with a block write rate;

Determining a filling measurement of an amount of data units in the buffer at a specified time instant;

Setting a ratio of a read rate and the write rate, on the basis of the filling measurement; and

Reading data units from the buffer with the read rate.

The invention also relates to a computer program product, enabling a processor to execute such method.

An embodiment of such a buffer management system is known from the international patent application WO99/35876. The known system is part of an asynchronous transfer mode (ATM) network, usable for streaming Pulse Code Modulated (PCM) audio. More in particular, the link between a mobile switching centre (MSC) and a base transceiver station (BTS)—the latter being the local station which sends wireless data typically to a mobile phone—is described. The system may be used for streaming audio, which means that the playing of the audio starts before the audio file has been downloaded entirely, to avoid waiting for several minutes. Blocks of data units—called cells in the known document—are written in a first buffer at a block write rate determined by a first clock clk_1 before going over the network link. The blocks are coming out of the network with a read rate determined by a second clock clk_2. The whole system consisting of the two buffers, and in between the network link, is treated as a single buffer. If clk_2 is slower than clk_1, the buffers—which are for practical reasons of a limited size—start running full. So data will be lost at some point, resulting in a decreased audio quality. Similarly if clk_2 is too fast, the buffer will run out of data, leading to e.g. a repetition of the previous blocks at the receiver side.

The buffer is dimensioned so that for typical network delays there are always enough blocks available for reliably playing the audio at the receiver side. The audio is played at a delayed time, corresponding to the amount of data units present in the buffer. E.g., before playing starts, 10 seconds of audio are loaded in the buffer. If at any time during the playing download of audio blocks stagnates, the receiver can continue playing from the content stored in the buffer. Prior art buffer management systems are concerned with keeping the audio stored in the buffer at a reasonable level. E.g. in the known system, if the buffer filling runs over an upper level, a sample rate converter at the transmitter side groups input samples into blocks of less samples, so that only as much data is written into the buffer as is read out at the receiver side. Similarly, if the buffer runs empty because the receiver consumes too many samples, the sample rate converter writes more samples into the buffer than on average.

It is a disadvantage of the known system that since the focus is on maintaining a well-filled buffer, the audio playing delay corresponding to the filling control strategy is very variable. Networks may introduce large delay jitter of arrival times of different blocks due to the many components that participate in the transfer. E.g. in a multicast backbone (Mbone) link, block arrival times may vary typically by up to plus or minus 150 ms, and for some blocks even larger delays may occur. But on the other hand, in e.g. a voice over internet protocol (VOIP) telephone conversation a delay of up to 100 ms is acceptable, above which the other party seems very hesitant in its conversation.

It is a first object of the invention to provide a system as described in the opening paragraph in which a delay between when a data sample is received and when it is outputted can be controlled. Data is preferably audio data, but may be data of any continuous function, which may be resampled, especially if resampling is hardly noticeable to a human.

This first object is realized in that

an input time measuring component is comprised, arranged to measure an input time instant of input of the data unit in the buffer management system, and yielding an input time measurement; and

a delay control component is comprised for controlling the delay by controlling the data rate conversion component on the basis of the filling measurement and the input time measurement.

Note that if the system is an in-room wireless audio connection system, e.g. with a number of receiving surround loudspeakers, then the time of sending a block of audio data units may be equated with the time of reception. Delays in the transmitter need in general not be taken into account if the transmitter is the same for all receivers. The term room should be interpreted in a broad sense and can apart from a consumer's living room also encompass a factory floor, movie theatre or even a limited outdoors space. In some audio systems a larger degree of control over the end-to-end delay of playing an audio sample is desired than e.g. for VOIP. E.g. a wireless headphone may require a delay below 30 ms in order not to loose lip-synchronization between the movement of lips as seen on a television screen and the speech as heard over the headphones. Analog systems show hardly any delay, but digital systems do, e.g. due to packet sending, processing such as decompression, etc. When there are a number of surround loudspeakers—e.g. a left and right surround loudspeaker—, the requirements on the delay are even more stringent. In this case not only the average value of the delay should be relatively low, but the variation of the delay—the so-called delay jitter—should be relatively low too, in the order of a few samples, typically e.g. below 5 samples. In other words, by having a constant end-to-end delay for each loudspeaker, each loudspeaker outputs as sound roughly the same sample. If however the left surround loudspeaker would output sample x and the right loudspeaker outputs sample x+y, where y is a variable delay from 0 to e.g. 50 samples, the virtual sound source position or stereo image is no longer stable, since delays of arrival in the human ear of the sound produced by the left and right loudspeaker produce the virtual sound source illusion.

Three types of delay may be identified in a digital data communication system. First there are the delays of processing elements, such as a decoding delay. These delays may be variable, but often a fixed time slot is reserved for the processing, hence they can be neglected in a delay control strategy. Second, there are action delays, which occur because an action to occur is early or late, typically because a clock controlling the action runs fast or slow relative to a reference clock. E.g. a block of data may be input in the system, and written to a buffer at a variable time instant before a periodic read out from the buffer. Third, there is the delay corresponding to a buffer filling. If data units are read out of a buffer with a particular read out rate, there is a delay between read out of the first and the last data unit in the buffer equal to the number of data units in the buffer divided by the read out rate. A data sample traversing a chain of such processing elements, buffers and actions, will experience a total end-to-end delay. If certain parts of the delay are beyond the influence of the apparatus, e.g. a clock retardation, they can be compensated by actions and buffer fillings which are controllable, so that the total end to end delay is substantially constant, or at least controllable.

In the system according to the invention, an input time instant of a data unit is measured by the input time measuring component. Rather than just measuring how full the buffer is, the amount of buffer filling can compensate for delays. This input time measurement is then send to a delay control component which makes sure that the filling of the buffer is always such that the delay is controllable, and preferably in some systems roughly constant. The delay control component does this by using a flow equation taking read and input times and buffer filling into account as described below in the Figure description. Note that in the simple embodiment in the Figure description, there are no delays before input of a data unit and writing of the data unit in the buffer. In this simple embodiment there is an end-to-end delay comprising only two delay components, namely a difference between an input time instant (being hence equal to a write time; hence the write rate is the input rate) and a read time, and a filling delay of the buffer. Also it is supposed that there is a constant—hence neglectable—delay between reading from the buffer and outputting of the data unit by the loudspeaker. If more delays occur in the system, a more complex end-to-end delay equation results, as is illustrated by more complex embodiments below.

Note that the data units are written as blocks into the buffer. In a digital communication system they are typically also input in frames of a number of data units. However they may also arrive at the antenna one by one. In this case it is assumed that they are accumulated until there are enough data units to decode a block of samples, which block of samples is then written into the buffer.

An embodiment of the buffer management system comprises a read time measuring component, arranged to measure a read time instant of a first data unit, and yielding a read time measurement, and in the buffer management system embodiment the delay control component is arranged to control the data rate conversion component on the basis of the read time measurement. The read times may be fixed, e.g. dictated by the delay control component, but may alternatively also be measured and send to the delay control component.

In a VCO-embodiment the data rate conversion component comprises a voltage controlled oscillator (VCO). If e.g. the samples are read out too slowly and the buffer risks getting filled up, leading to an increase in delay, the read rate from the buffer is turned up, i.e. the samples are sent to the loudspeaker at a faster rate.

In an SRC-embodiment the data rate conversion component comprises a sample rate converter (SRC), arranged to produce a second number of samples out of a first number of samples. In the case where the output rate is fixed by the system, if an increased number of samples has to be read to avoid an increase of buffer filling, but the same number of samples has to be output, the sample rate converter can produce a lower second number of samples by interpolating samples with the first number of samples as input. Obviously the VCO and SRC can be combined in a single system. If the tolerance—the amount of clock rate a clock is allowed to vary at a particular time instant from its average or nominal value, e.g. due to temperature changes—of the clocks is small, typically below 100 parts per million (ppm), then a VCO is preferable, otherwise an SRC is preferable.

It is further advantageous if the buffer management system comprises a decompressor, and the delay control component is arranged to control the data rate conversion component on the basis of a decompression delay associated with the decompression or an amount of data units are in a second buffer. Further delays in the system, such as associated with decompression, transport stream decoding, or digital/analog conversion, may also be compensated for by the delay control component. An audio communication system typically sends data in a compressed stream, because resources, such as available bandwidth, are limited. The decompression may take a fixed amount of time for each block or may even take a variable amount of time. As long as this decompression time is measurable it can be compensated. The decompression time may be measured explicitly, e.g. as a difference of timestamps of a data unit or block entering and leaving the decompressor, or implicitly as an amount of data units or block queuing in a buffer before the decompressor to be decompressed (the slower the decompressor, the more data units have to queue up).

The buffer management system is advantageously incorporated in a digital audio receiver, which further comprises a radio receiver component. Typically this radio receiver component is present because the receiver receives wireless audio, which is modulated on a carrier wave. The buffer management system may also be incorporated in a wired network. Wireless audio products are especially suited for home cinema applications, in which case the consumer is liberated from having to connect all kinds of wires. Particular examples of such products are a wireless headphone and a stand-alone surround sound loudspeaker.

It is a second object of the invention to provide a method of buffer management as described in the opening paragraph in which a delay between when an audio sample is sent and when it is played can be controlled.

The second object is realized in that

an input time measurement of an input time instant of input of the data unit in the digital audio receiver is performed; and

the delay is controlled by setting the ratio of the read rate and the write rate also on the basis of the input time measurement.

Prior art contains numerous methods for maintaining a buffer filling at a reasonable level, e.g. in between empty and full so that there is a minimal risk of underflow and overflow, but these buffer control techniques do not care about end to end delays. Hence there are no measurements indicative of delays in the system, such as the input time measurement, which are used in determining a required buffer filling for a substantially constant or in general controllable end-to-end delay.

These and other aspects of the buffer management system, digital audio receiver, headphones and stand-alone surround sound loudspeaker according to the invention will be apparent from and elucidated with reference to the implementations and embodiments described hereinafter, and with reference to the accompanying drawings, which serve merely as non-limiting illustrations.

### IN THE DRAWINGS

FIG. 1 schematically shows an embodiment of the buffer management system according to the invention;

FIG. 2a schematically shows a timing diagram of writing into and reading from the buffer;

FIG. 2b schematically shows the output of audio samples as a result of a varying read rate;

FIG. 2c schematically shows the number of blocks of data units in the buffer;

FIG. 3a schematically shows a fast buffer readout strategy to correct for the extra buffer filling after two consecutive write steps;

FIG. 3b schematically shows buffer management as in prior art document WO99/35876;

FIG. 3c schematically shows constant end-to-end delay buffer management as in a preferred embodiment of the buffer management system according to the invention;

FIG. 4 schematically shows the reading of data units from the buffer for constant end-to-end delay in the case where the read rate is slow compared to the write rate;

FIG. 5 schematically shows an exemplary embodiment of a wireless digital audio receiver comprising an embodiment of the buffer management system;

FIG. 6 schematically shows an embodiment of the buffer management system functioning with a voltage controlled oscillator;

FIG. 7 is a schematic illustration of an example of how the data rate conversion keeps the end-to-end delay for all audio samples roughly constant;

FIG. 8 is a schematic timing diagram to illustrate a more advanced constant end-to-end delay strategy;

FIG. 9 schematically shows a system for wireless in-home audio transmission between an audio source unit and two loudspeakers;

FIG. 10 shows an advanced example of a timeline of data processing in a transmitter and two receivers; and

FIG. 11 shows corresponding to FIG. 10 the reception of data in the receiver, processing and output via a digital/analog converter;

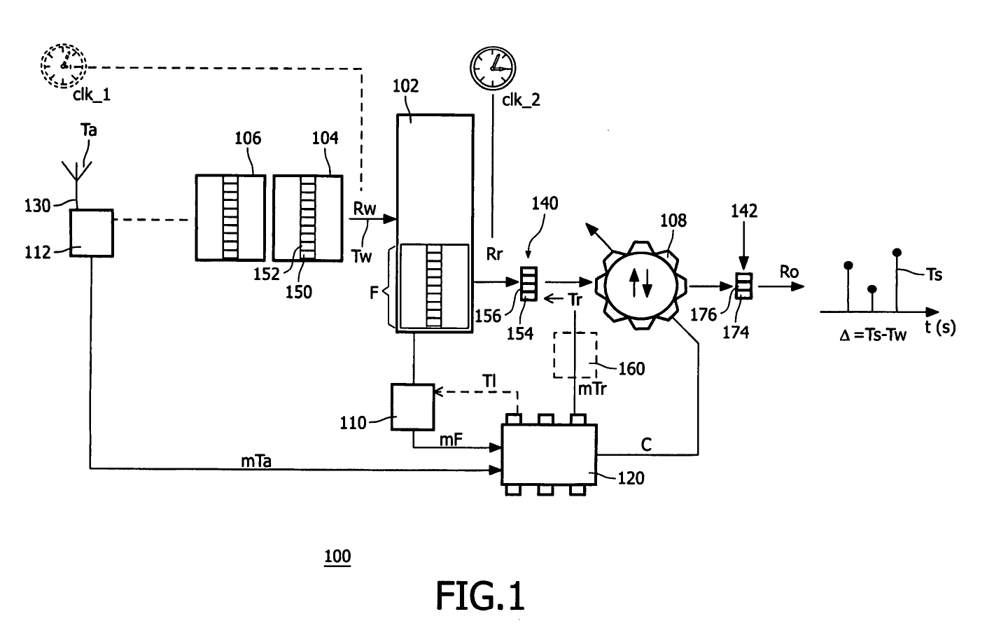

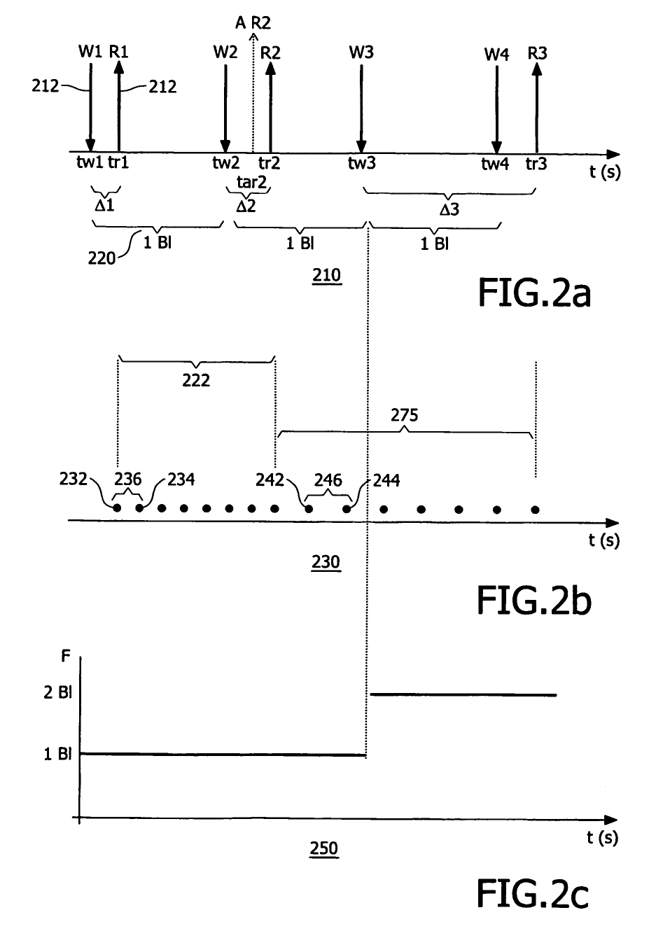

In FIG. 1, blocks 104, 106 of data units 150, 152 enter the buffer management system 100 in a receiver. Although the buffer management system 100 could be connected with the transmitter of the data units by wires, the buffer management system 100 is preferably connected wirelessly by means of an antenna 130. The term “data unit” is used to indicate a piece of data, e.g. a piece of a digitized audio, video or other time-continuous data signal—such as e.g. captured by a sensor—, comprising at least one bit. In some embodiments a data unit is a sample of 16 bit PCM audio. In other embodiments the audio is compressed—e.g. sub band coded (SBC)—and the data units may comprise multiple samples and/or parts of samples. For simplicity of explanation, the term sample is sometimes used instead of data unit, the skilled person knowing how to modify the system for other types of data unit. A block is a number of data units grouped together—possibly with extra control bits—, and read and written together. In an exemplary numerical embodiment in this text the number of samples in a block is 128. For simplicity of explanation (as in FIGS. 2, 4, and 7), an input time instant Ta of arrival of a first data unit of a block of data units in the buffer management system 100 (e.g. at the antenna 130) is equated with a write time Tw of the block in a buffer 102, hence there is a constant delay between the arrival of a data unit at the antenna 130 and the writing of the data unit in the buffer, which delay is for simplicity of the explanation set equal to zero. The input time instant Ta may be measured in different ways, e.g. when it enters the receive buffer 506, or by a first processing element, etc. In more advanced embodiments, all delays between Ta and Tw also have to be taken into account in the end-to-end delay control. Hence, the blocks 104, 106 are written in the buffer 102, at write time instants Tw, the number of write time instants Tw per second being the write rate Rw. At a particular time instant T1, the buffer is filled with an amount F of data units, e.g. one block of data units, ready to be read out by the next read command. Data units are read out with a read rate Rr. Readout can be per data unit—e.g. per sample- or per block.

The writing into and reading from the buffer 102 is illustrated in FIG. 2. At a first write time instant tw1, a first write action W1, 212 into the buffer is performed. E.g., the buffer may be empty before tw1, and contains one block after tw1. At a first read time instant tr1, the block is read out, leaving the buffer empty for a second write action W2. After this the receiver will read out from the buffer 102 at time instant tr2. The write actions occur at write times tw dictated by a first clock clk_1. This is the clock of the transmitter, and it is not known in the receiver. However, the transmitter transmits blocks and they arrive at the receiver nearly instantaneously, so the moments of arrival can be used by the receiver to measure the first clock clk_1 of the transmitter. But the receiver has no control over the first clock clk_1 or its variations around its nominal rate. The read actions occur at read times tr dictated by a second clock clk_2, the clock of the receiver. The reference for the first read time tr1 may be taken as the time when the first data unit 154 of a particular block, which was written into the buffer 102 at tw1, is read out, irrespective of whether the data units are read out solo or in blocks. If the rest of the system after read out from the buffer 102 consists of fixed delays, the reference point may also be taken as a reproduction time instant Ts when the sample is played through the loudspeaker. The difference of the reproduction time instant Ts and the write time instant Tw—or if further delays occur before the block 104 is written into the buffer 102, the block arrival time Ta—is the end-to-end delay Δ, which is to be controlled by the buffer management system 100. In FIG. 2a, for simplification purposes all processing components before and after the buffer 102 are neglected—assumed to introduce a constant or negligible delay—so that only the writing into and reading from buffer 102 dictated by respectively the first clock clk_1 and the second clock clk_2 are to be taken into account.

If clk_1 and clk_2 are perfectly synchronous, the reading will always occur at a particular time interval after the writing, giving rise to a first delay Δ1. In the following it is assumed that compared to the fixed time instants of writing tw1, tw2, etc. by the first clock clk_1, the second clock clk_2 jitters, more precisely temporarily runs slow (in fact it is the relative clock difference which is important). Although the buffer management system 100 can also be used in cases where the variation of the clocks is of another type, it will be advantageous to use in cases where the first and second clocks clk_1 and clk_2 have the same nominal value, but a small, unknown jitter around this value, of typically up to 1000 ppm. These cases are elaborated in this text. In FIG. 2a it is assumed that the second clock clk_2 runs slow compared to the first clk_1 —consistently, i.e. over a number of write/read cycles—, hence the read actions occur ever later compared to the write actions. Also shown in FIG. 2a with the dashed arrow AR2 is the reading of the second block by a second buffer management system, e.g. in a second stand alone loudspeaker, which occurs at a time tar2 which is offset compared to tr2. Hence when these two loudspeakers play their respective samples at a particular time instant these samples will not correspond, leading to an incorrect stereo image.

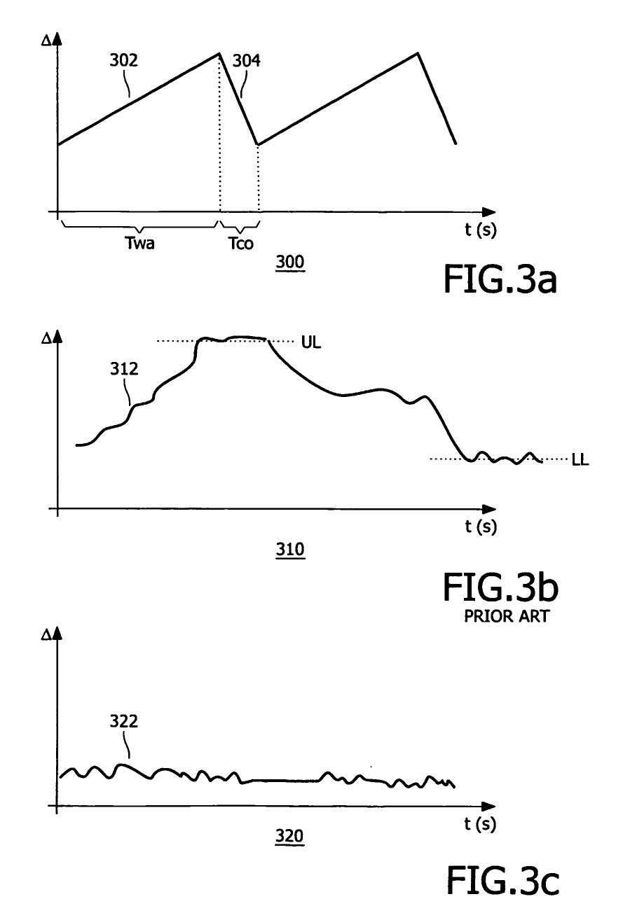

Returning to FIG. 2b, the samples are outputted more slowly due to the slow running clk_2, with a larger second intersample distance 246 between a third sample 242 and a fourth sample 244 than a first intersample distance 236 between a first sample 232 and a second sample 234. At a certain moment, in the example a third read action R3 is delayed by a third delay Δ3 of more than one block, hence a fourth write action W4 occurs before the third read action R3. As can be seen in FIG. 2c, from that moment on in between a write and a read action, there are always two blocks in the buffer 102, rather than one block. If the second clock keeps running slow, after some time there will be three blocks in the buffer 102, and so on. But more deleterious than an increase in buffer filling, is the corresponding increase in delay Δ. If e.g. the clock of a left surround loudspeaker runs too slow, in respect to the first clock clk_1 of the transmitter which transmits audio to surround loudspeakers, and the clock of a right surround loudspeaker runs too fast, in sync with the first clock clk_1, or less slow, the samples output by the two loudspeakers correspond to ever more separated time instants of the audio signal, hence the stereo image is severely disrupted. To bring back the buffer filling or the delay to a typical value, different strategies may be tried as shown in FIG. 3.

In FIG. 3a, instead of reading a block of 128 samples each read time instant Tr, one or a few samples extra are read. If e.g. 8 extra samples are read during each read action, after 16 (=128/8) read actions the buffer filling has returned to the normal filling of 1 block, provided that it takes longer than these 16 write/read cycles for a next write action to catch up with a previous read action again. This will certainly be true in case the clock rates differ by only a few ppm, for which the corresponding delay variation is indicated by the soft sloping line 302. However, such a fast correction action 304, although it is perfectly useful for buffer filling management on itself, is bad for delay management. Firstly during the long period Twa, the delay keeps rising, hence this keeps leading to a bad stereo image. Then during a quick recovery period Tco, the delay is restored again to e.g. 1 block. However, the recovery interval may occur a different times for the two loudspeakers, leading to the fact that even for clocks varying with nearly the same trend, at some moment in time one loudspeaker still has two blocks delay and the other already only one block delay. This introduces a relatively quick deterioration of the stereo image. FIG. 3b shows the delay which will occur with a correction strategy as in WO99/35876. Since in this known system buffer management only occurs when the buffer is filled to an upper limit UL or to a lower limit LL, the delay typically resides around values corresponding to such buffer filling, with uncontrolled transitory periods 312 in between.

The only way to maintain a good stereo image is to control the delay Δ—more precisely keep it roughly equal to a predefined value—for all the loudspeakers as shown in FIG. 3c.

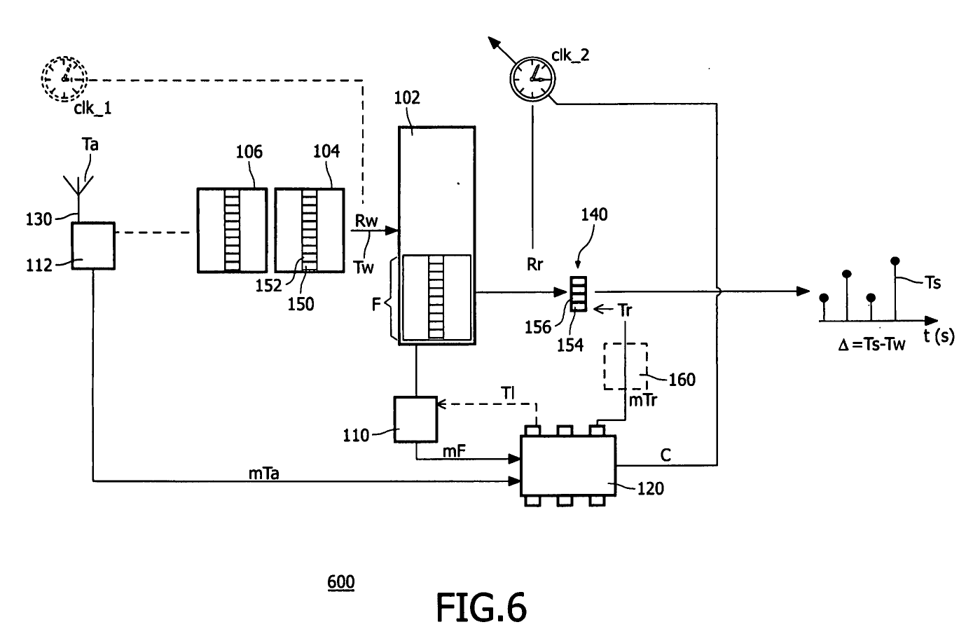

Returning to FIG. 1, when more samples are read than a block, a data rate conversion component 108 takes care of the conversion of a first number 140 of read samples 154, 156 to a second number 142 of samples to be output 174, 176. The output audio is typically after digital/analog (D/A) conversion reproduced by a loudspeaker. The samples may of course also be sent to another apparatus, such as e.g. a storage device. The data rate conversion component 108 may e.g. be a sample rate converter. Numerous SRC techniques exist in prior art, e.g. interpolating filters, techniques which extract and substitute repetitive patterns such as PSOLA, etc. An advantageous sample rate converter first upconverts the audio signal, e.g. with a factor 10, then Nyquist filters, and then downconverts, e.g. with a factor 7, so that any conversion rate can be easily achieved. With an SRC the second clock clk_2 can be a relatively cheap fixed clock, e.g. a crystal oscillator. Instead of using a SRC, a variable clock 610 producing a variable read rate Rr such as a voltage controlled oscillator may be applied, as shown in FIG. 6. If more samples should be read out of the buffer 102 to keep its filling at a desired amount F, corresponding to a desired delay Δ, the read rate Rr (clk_2 rate) is turned up, and vice versa.

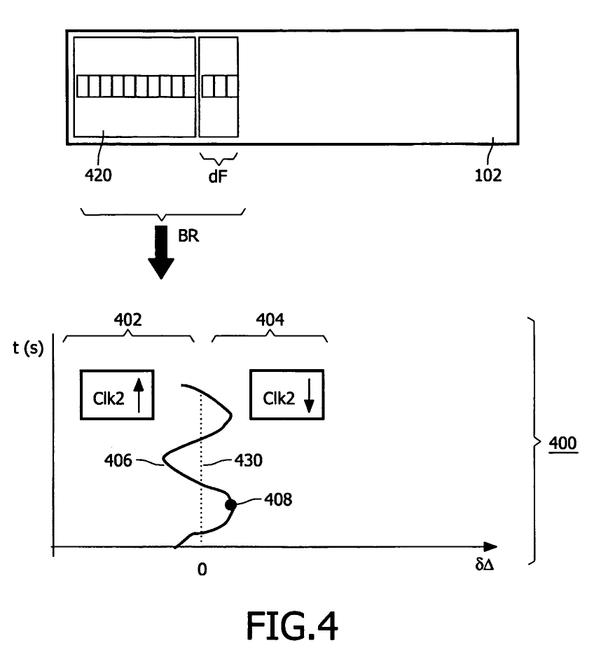

Focus will now be put on the adaptation of the read strategy dependent on the relative fastness or slowness of the second clock clk_2, or the read rate Rr, since the man skilled in the art will given the above examples know which data rate conversion strategies to apply. The principle of the invention is schematically illustrated by means of FIG. 4.

As a simple illustrative example compensating missynchronisation of clk_2 relative to the input times Ta, suppose there is a fixed delay before the writing into buffer 102 and that the desired amount F of data units in the buffer 102 just before a block read action is one block 420 of 128 samples. This amount F can be advantageously measured as zero data units in the buffer 102 just after a read command has been executed. Alternatively, the buffer filling can be checked before a read command. This corresponds to a fixed delay, e.g. the first delay Δ1 of FIG. 2a. Graph 400 shows the variation of delay δΔ due to the relative variation of the second clock clk_2 read rate Rr versus time. If the first clock clk_1 of the transmitter and the second clock clk_2 of the receiver are in sync, then δΔ is zero, which is indicated by baseline 430. To the left of baseline 430 there is a “fast receiver clock” domain 402, and to the right the second clock clk_2 is slow compared to clk_. For an occurrence 408 in the “slow receiver clock” domain 404, more samples BR have to be read out than 128 samples, namely BR=128+dF, to maintain the amount F of filling at 1 block (which will be written in the buffer at the next write time instant), or more precisely to maintain a desired delay Δ. If, as can be seen in FIG. 2b, in an interval of slow clk_2, there are 8 samples to be output, they can be constructed from 1 block+dF samples by the SRC. As long as the clocks do not differ too much, an interpolated sample is perceptually very similar to what an actual audio sample would be like at exactly the correct time instant for the sample, corresponding to the desired delay. Hence, the stereo image is reproduced rather faithfully. And since the buffer filling is again the same as during the previous write/read cycle—there has been no extra filling, leading to increased delay—the delay Δ remains substantially constant over the successive write/read cycles.

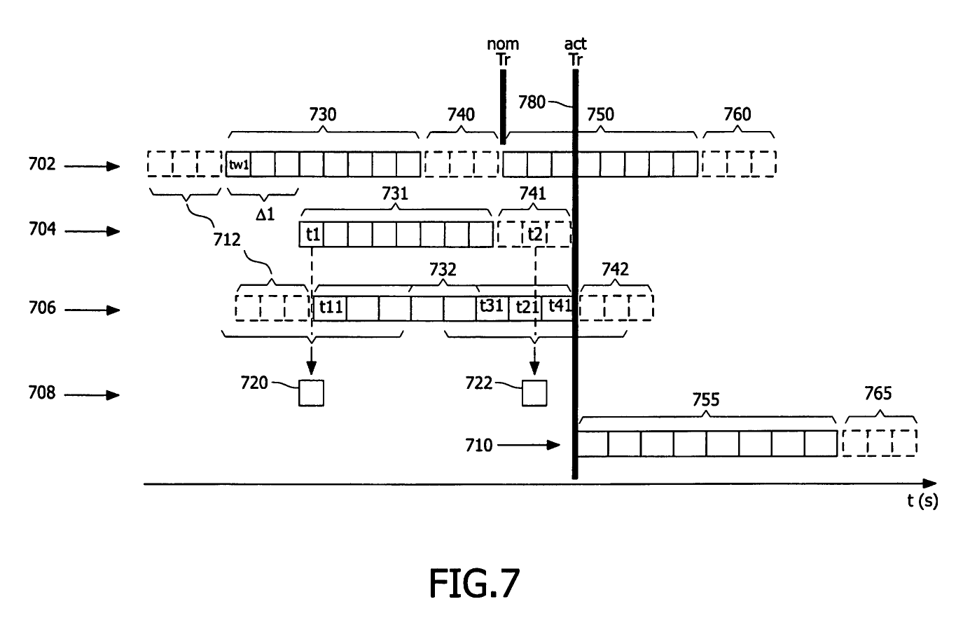

This is illustrated more clearly with the aid of FIG. 7. Row 702 shows the data units—for simplicity considered to be samples—as they are written into the buffer 102, e.g. a block 730 and hence the block's first sample is written at tw1. Row 704 shows the samples as they are read out under standard operation, by which we mean that the clocks clk_1 and clk_2 are exactly synchronized. In the example this first sample is read out of the buffer at t1, which means that there is a delay equal to Δ1 being 3 samples. Under standard operation, the samples 741 being identical to the samples 740 would be read out next; actually a new block of 8 samples would be read out next. Row 706 illustrates what would happen with a slow second clock clk_2, hence the samples 732, corresponding to the samples 730, are shown schematically as rectangles rather than squares, to illustrate the time stretch. At a next read time instant 780 the samples 742 corresponding to 740 would be read out under the direction of the slow clk_2, but this would lead to an increasing delay as explained above. Hence a clean slate strategy has to be applied, which means that samples 755 are read out corresponding to written samples 750. However, this would mean that samples 740 have never been read out, i.e. they have been dropped, and also the latter samples in the interval at times t21, t31 and t41 have an inappropriate delay. As explained above, the problem is solved by reading out 3 extra samples and sample rate converting, e.g. interpolating. Row 708 shows interpolated samples, only two for clarity. At the beginning of the block samples such as sample 720 are interpolated with a previous extra amount of samples 712. Theoretically this should be at time instant t1, but in practice the sample may also be output at time instant t11, both time instants differing only infinitesimally. At the end of the block, e.g. at time instant t2, one can see that sound samples should be similar to the extra samples 741 rather than similar to the last of the samples 730, so the interpolation of sample 722 takes into account the extra read samples 742 as well. If the clock jitters with only a few ppm this scheme is of course highly exaggerated, but the same principles apply.

Mathematically this can be written as a flow equation (Eq. 1) of constant flow in and out the buffer 102, leading to a constant filling amount F:
Δ^{nom}=cte=T_{R}^{nom}−T_{W}^{nom}
Δ^{act}=cte=T_{R}^{act}−T_{W}^{nom}
dF=T_{R}^{act}−T_{R}^{nom} [Eq. 1]

Hence the extra amount dF of samples to be read is equal to the difference between the actual read time T_{R}^{act} and the nominal, i.e. desirable read time T_{R}^{nom}, i.e. equal to the slowness of clk_2. Stated otherwise, the variation of delay δΔ=Δ^{act}−Δ^{nom} as a time difference corresponds in terms of buffer filling to a particular amount of samples dF, the write time T_{W}^{nom} being taken as a fixed reference.

Returning to FIG. 1, this equation is evaluated by a delay control component 120. A write time measuring component 112 measures when a block is input in the data management system (or in the simplified example written into the buffer 102)—at input time instant Ta— and sends this as an input time measurement mTa—or time stamp—to the delay control component 120. At a specified time instant T1, e.g. right after a block has been read from the buffer 102, a buffer filling measurement component 110 measures the amount F of data units in the buffer, sending a filling measurement mF to the delay control component 120. If required the read time Tr may also be sent to the delay control component 120 by a read time measuring component 160. The delay control component 120 calculates whether the extra amount of data units dF in the buffer is correct according to Eq. 1. If not it instructs via a control signal C the data rate conversion component 108 to read more resp. less samples and convert them to the appropriate data output rate Ro. When the second clock clk_2 runs slow only by a fraction in the order of ppms, the data rate conversion component 108 will only interpolate samples or change the VCO-clock in a small fraction of the write/read cycles, well spaced apart. The explained strategy is actually a strategy maintaining dF−T_{R}^{act}+T_{R}^{nom}=0. It should be noted that the extra amount dF can also be calculated directly, and any rate conversion strategy can make use of these calculations. In this simplified description, no variable delays were assumed before the writing into the buffer 102 or after the reading from the buffer 102. Obviously the system is especially useful if there are further sources of delay, which can be compensated by control of the read out (i.e. control of the filling) from buffer 102, or if desirable even more controllable buffers.

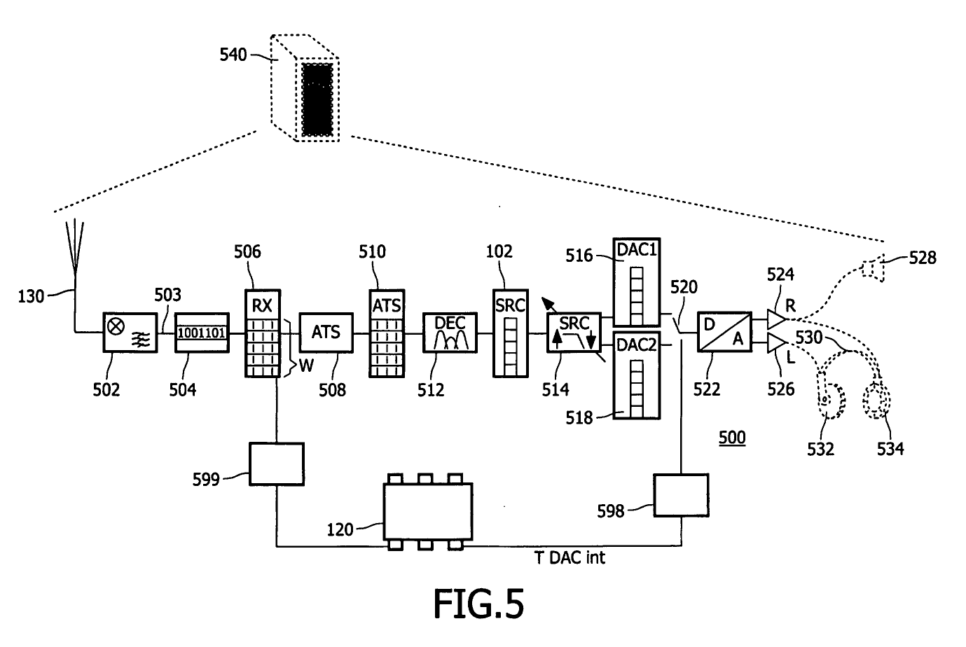

FIG. 5 schematically shows an embodiment of the buffer management system 100 as incorporated in a digital audio receiver 500. A wireless digital audio stream comes in via antenna 130. A radio reception component 502 performs the necessary tuning and demodulation. At its output 503 emerges a digital baseband transport stream. A synchronization component 504 is arranged to perform bit and frame synchronization, i.e. recovery of the clock of the transmitter before sampling occurs. Typically a synchronization word is used, such as a Barker sequence before each block—also often called frame—, as is known in the state of the art. The synchronization component 504 may also remove stuffing bits. Suppose the clock of a CD-player at the transmitter side has a clock rate of 1.4 Mbit/s and the transmitter clock transmits at 140 kbit/s, this clock possibly being derived from the CD-player clock, or independently generated. If at a time instant when the transmitter wants to transmit a block of data, the CD-player has not put enough bits in a transmitter buffer (not shown) yet, then the transmitter can fill the missing samples with stuffing bits. After removal of the stuffing bits, the data is at the receiver side again in the clock domain of the audio source apparatus such as a CD-player, rather than in the clock domain of the transmitter, and it is typically this source apparatus clock which has relatively large tolerances up to 1000 ppm i.e. 0.1%.

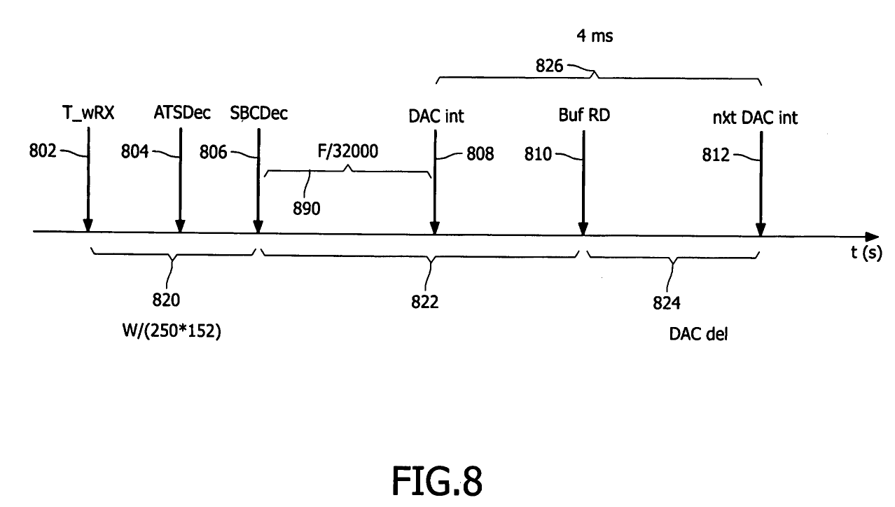

The blocks are then written in a receive buffer 506. An audio transport stream (ATS) decoder 508 strips all the transport protocol data, and writes the ensuing blocks in an ATS buffer 510. A decompressor 512—e.g. a sub band decoder—decompresses the compressed audio blocks and writes PCM audio blocks in the buffer 102. Under control of the delay control component 120, a sample rate converter 514 writes samples in one of two DAC buffers 516 resp. 518. A D/A converter 522 alternately reads from the first DAC buffer 516 resp. the second DAC buffer 518, where in the mean time the other buffer is filled by writing into it a block of samples. This is realized with a controllable switch 520. The analog audio signals e.g. a left L and right R signal, are then e.g. sent to a left loudspeaker 532 and a right loudspeaker 534 of headphones 530, after amplification by a left amplifier 526 and a right amplifier 524. Alternatively, the receiver may also be incorporated in the cabinet 540 of a loudspeaker, in which case the audio signal is sent to a loudspeaker 528. The receiver 500 may be fabricated as an OEM module to be incorporated in e.g. a loudspeaker cabinet 540 of an original equipment manufacturer, or it may even be a plug in module to be attached to e.g. a preformed connector of headphones 530, the latter making it easy for an end consumer to upgrade his system. Note that for simplicity the connections to the measuring components already shown in FIG. 1 are not redrawn, but rather only extra measurement connections are drawn, needed for the advanced example illustrated with FIG. 8 below.

With the aid of FIG. 8 a more complex exemplary constant delay strategy is described, taking into account an example of a delay before and after buffer 102.

At a first time instant 802, a word—or a frame of words—is written in the receive buffer 506. It is assumed that an ATS frame consists of 128 samples on the one hand, and 152 words of 24 bits, i.e. 3648 bits, on the other hand. Note that this number includes an oversampling of a factor 4. There are 250 frames coming in every second. At a second time instant 804, the transport data has been stripped, and the audio content is written in the ATS buffer 510. At a third time instant 806, the audio has been decompressed and is finally written in the buffer 102. If the system works at 32 kHz, i.e. 32000 samples every second, an amount F samples in the buffer 102 corresponds to a first partial delay 890 of F/32000 seconds. The delay introduced by processing and scheduling of the transport stream decoder 508 and the decompressor 512 can be measured by a decoding delay measurement component 599, which is preferably arranged to measure an amount W of words left in the receive buffer 506 substantially immediately after the decompressor 512 has written a block in the buffer 102. Since there are 250 frames per second and 152 words per frame, this corresponds to a second partial delay 820 of W/(250*152) seconds.

Irrespective of the buffer filling amount F, a sample experiences a read-write delay 822, corresponding to the time difference of Tr-Tw (a read time instant 810—the third or write time instance 806). If there are F samples in the buffer, this always introduces an extra partial delay of F/32000. At a fourth time instant 808, the DAC switches to another DAC buffer. In theory, immediately before this fourth time instant 808 there could be the read time instant 810 (Tr in FIG. 1), and there would be no additional delay. However if the block reading occurs at another time instant, there is an additional DAC delay 824 until the block read from the buffer 102 in the DAC buffer (e.g. 514) is finally accessed for digital/analog conversion. The time between two DAC switches is 4 ms.

The total delay can be captured with the following equation (Eq. 2):
Δ=W/(250*152)+F/32000+(Tr−Tw)+(TnxtDACint−Tr) [Eq. 2]

The DAC switch time is measured by a DAC switch time measuring component 598, yielding the next DAC buffer switch time TnxtDACint.

Worst case analysis learns that for the numerical example a constant end-to-end delay of 8 ms is preferable. If the first, or especially third and fourth terms of Eq. 2 introduce less delay, to obtain a constant delay of 8 ms this has to be achieved by an increase in the amount F in the buffer 102, hence a temporal increase in the number of samples read out, and an accompanying data rate conversion strategy. Preferably the algorithm is a control algorithm: if F is such that the current delay is substantially equal to 8 ms nothing is done, but if the delay is too high the SRC is put in downsampling mode, and vice versa. The obtained accuracy is about two samples, which is enough for high quality stereo or surround sound applications.

The synchronization component 504, transport stream decoder 508, decompressor 112, data rate conversion component 108, delay control component 120, and measuring components 112, 110, 160, 598, 599 may all be realized on a processor (e.g. a DSP) or in hardware (e.g. an ASIC).

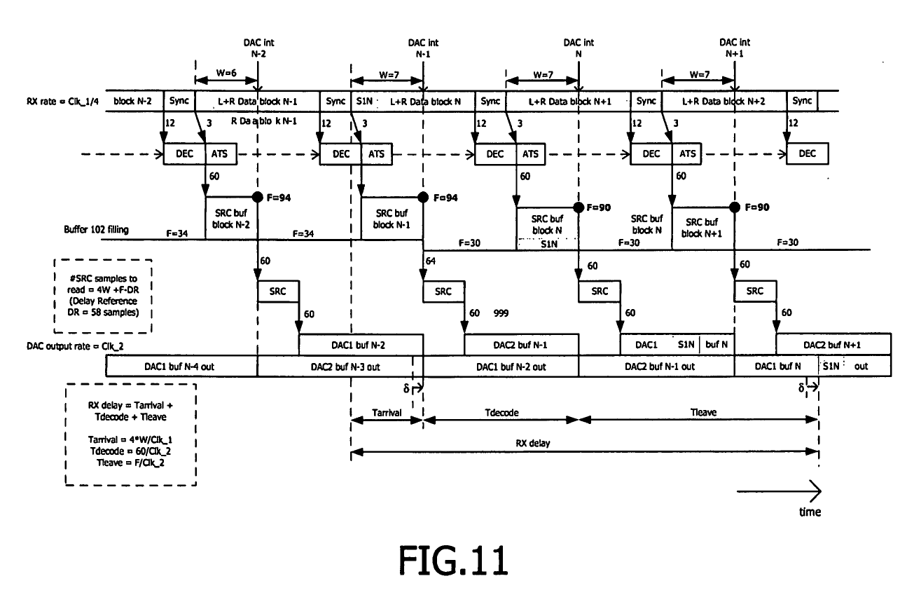

FIG. 11 shows a typical application for wireless in-home audio transmission in which the buffer management system proposed in this invention can advantageously be used. The application consists of an audio source unit 1100, containing a stereo audio source, and two receiving units 1110, 1120 for reproducing respectively a left and a right audio channel.

In the source unit 1100 e.g. a CD player 1101 with audio sample clock clk_1 is connected to a base station 1103 by means of a digital connection 1102, carrying left and right audio information and sample clock rate information. The base station 1103 has an integrated transmitter unit arranged for wireless transmission of audio data via antenna 1104 to both receiving units 1110, 1120. In most wireless systems the base station 1103 will contain means for bit rate reduction (e.g. MP3 or SBC encoding) to use available RF spectrum frequencies efficiently, and means for frame formatting to enable data recovery at the receiving end. The encoded left and right audio channels are broadcasted together so that they arrive at approximately the same time instance on the receiving antennas 1111 and 1121. The receiving units 1110 and 1120 decode the received audio data and apply the decoded audio samples of the left and the right audio channel via a DA converter to respectively loudspeaker 1113 and 1123. Each destination unit 1112, 1122 has a local DA clock clk_2a, clk_2b (this is taken as the master clock for the actions in the receivers). This local clock has the same nominal value as clk_1 but its frequency can deviate as much as 1000 ppm (0.1%) from the nominal value due to tolerances, temperature effects and aging.

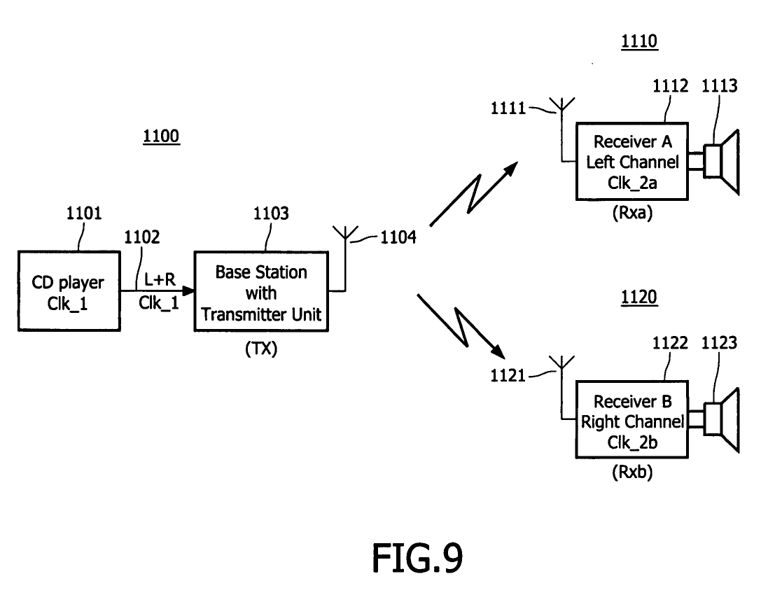

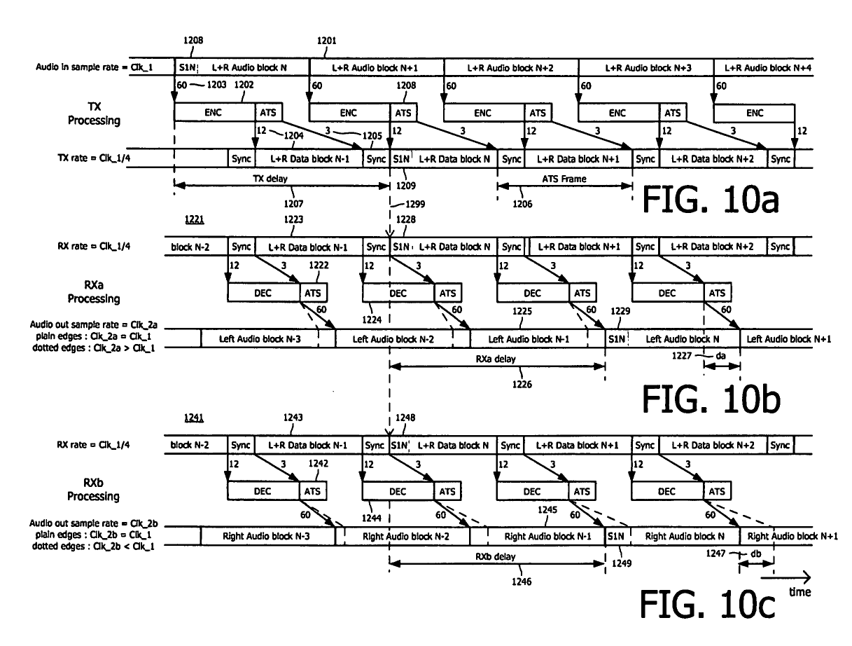

FIG. 10 shows the data flow for the system of FIG. 9 (and receiver 500 of FIG. 5). In FIG. 10a the data flow in base station 1103 is shown. Audio samples 1201 for left and right channel are entering the base station with a sample rate clk_1. It is assumed that an audio encoder 1202 is used to reduce the bit rate with a factor of 5. A further assumption is that the audio encoder works with an input block size of 60 audio samples (the 60 samples being transferred to the audio encoder are shown as arrow 1203) resulting in an output block size of 12 data units (1204), having per data unit the same number of bits as the audio samples (e.g. 16 bits). To enable the receiving units to determine when a new block of encoded audio data starts, a block 1205 of 3 sync units (with the same number of bits per data unit) and a block 1204 of 12 data units are packed together in an Audio Transport Stream (ATS) frame 1206 by means of an ATS frame generator 1207. This is a small processing block that builds the frame together. The sync block 1205 can contain a sequence 504 for bit synchronization and frame synchronization (e.g. a Barker sequence) but also other system-specific information. With the figures selected for this example, the data unit sample rate—which is equal to the transmission TX rate—is ¼ of the audio sample rate clk_1 (derived from clk_1). For the example shown the ATS frame has a fixed phase relation with the input blocks 1201 of the audio encoder 1202, resulting in a fixed TX delay 1207 between the first audio sample S1N of block N (1208), entering the input buffer of the source unit (through connection 1102), and the encoded version of sample S 1N (1209), leaving the output buffer of the source unit (to the transmitter unit and transmitting antenna 1104).

The buffer management system can also work with a data unit sample clock that is independent from audio clock clk_1. In this case, gaps in the ATS frame can optionally be filled with stuffing bits, which have to be removed at the receiving end before further processing of the data units.

In the more general case TX delay 1207 can be variable. If an overall constant end-to-end delay is needed (e.g. for avoiding lip sync problems with a TV picture at source side), the variable part of TX delay 1207 can be compensated by an appropriate implementation of the buffer management system in the receiving units. If the input time instant Ta is measured at the transmitter (i.e. e.g. the time instant of a data unit leaving the CD player, and send to the receiver as a timestamp), or at least derivable somewhere in the buffer management system 100, instead of just in the receiver, such a buffer management system 100 is realized.

It is also possible to pack multiple SBC blocks in one ATS frame. In this case, the algorithm of the buffer management system in the receiving unit(s) has to take this (known) frame structure into account.

Receiving units 1110 and 1120 receive the ATS frames at almost the same time instant as they are transmitted by base station 1100. This is shown in FIGS. 10b and 10c by the relative position of reference sample S1N in the transmitted (FIG. 10a) and the received (FIGS. 10 b and 10c) data streams (arrow 1299). The ATS decoder units 1222, 1242 examine the data streams 1221, 1241 as they are received in the input buffers and they look for the synchronization symbol. After bit and frame synchronization, the start of data block units 1223, 1243 is known and audio decoder units 1224, 1244 can start decoding a block of data when 12 data units are available. After decoding, 60 audio samples will be written as blocks 1225, 1245 in the output buffer. In destination unit 1110 only the samples of the left audio channel will be used and in destination unit 1120 only the samples of the right audio channel will be used.

If clk_2a and clk_2b are exactly equal to clk_1, the RX delay 1226, 1246 between receiving the encoded first sample S1N of a block N (1228, 1248) and outputting this decoded first sample S1N of block N (1229, 1249) to the DAC and the loudspeaker 1113, 1123 is the same for both receiving units 1110, 1120. In this case there will be no phase difference between both speakers.

On the other hand, if—for example—clk_2a is faster than clk_1 (FIG. 10b), the output blocks 1225 will be shorter (with block edges indicated by the dotted lines) and the RXa delay (1226) will be shorter than the nominal value. Deviation da (1227) with respect to the nominal value will accumulate in time if no corrective actions are taken.

In the same way, if—for example—clk_2b is slower than clk_1 (FIG. 10c), the output blocks 1245 will be longer (with block edges indicated by the dotted lines) and the RXb delay (1246) will be longer than the nominal value. Deviation db (1247) with respect to the nominal value will accumulate in time if no corrective actions are taken.

Clock differences between clk_2a, clk_2b and clk_1 can be compensated by means of a Sample Rate Converter (SRC). For the example of FIG. 10b (clk_2a faster than clk_1) the SRC can read more than 60 samples from the SRC buffer to write 60 samples 1225 to the DAC buffer, hence compensating the time difference. For the example of FIG. 10c (clk_2b slower than clk_1) reading less than 60 samples to produce 60 output samples is illustrated.

In order to get a good and stable stereo image, it is needed that the audio signals in clock domains clk_2a (1110) and clk_2b (1120) have a fixed phase relation with each other and with the audio signals in the source (1100).

Known algorithms for SRC control cannot be used for this synchronization since these algorithms are designed for synchronization between only two clock domains (e.g. clk_2a with clk_1 OR clk_2b with clk_1). The buffer management system as proposed in this invention will be able to provide synchronization between multiple clock domains (clk_2a AND clk_2b with clk_1 and therefore also with each other), even if there is no physical connection between the domains.

The synchronization mechanism to get a constant RX delay 1226, 1246—assuming TX delay 1207 is constant as shown in FIG. 10a—will be explained with the data flow diagram shown in FIG. 11. It is based on a possible receiver implementation, as shown in FIG. 5.

From radio reception component 502 the received data stream is written data unit per data unit to receive buffer 506 at a write rate Wr′ equal to Clk_1/4 (see FIG. 10b or 10c). Synchronization component 504 removes the sync data units and initiates decompressor 512 when a new data block of 12 units is available for decompression or decoding. The decompressed audio data is stored in SRC buffer 102.

When a DAC buffer is empty, a DAC interrupt is generated, e.g. DAC interrupt N−1 AC int N−1). At that moment buffer management system 100 measures or calculates Tarrival, which is the time difference between the first sample S1N of data block N and the DAC interrupt. For this implementation the data is entering receive buffer 506 monotonously at a known (nominal) rate Clk_1/4 so that Tarrival can also be represented by the number W of received words (samples) counting from the first sample S1N of block N (which is the first sample after the last sync block). If data is not received monotonously and/or if the transmitter delay is variable, Tarrival should be calculated in such a way that it represents the variable part of the delay between the first sample S1N in the input stream 1201 of the source unit and DAC interrupt N−1 in the receive unit.

DAC interrupt N−1 initiates the SRC block which reads a variable amount of samples from SRC buffer 102 and converts it to a fixed amount of output samples (60 in this example; arrow (999)) and writes these samples into the empty DAC buffer (DAC2 buffer in this example). The time Tdecode needed to output a complete DAC buffer is available for decoding and processing the received data. During this period three processes have to executed: ATS decoding (and verification if the system is still in sync), audio decoding (decompression), and sample rate conversion. Tdecode if fixed and equal to the number of samples per DAC block (60) divided by the output clock rate (Clk_2).

After DAC interrupt N−1 and after SRC, the receiver system will wait until the ATS processor initiates the decoding of data block N. This will be done after the last data unit of block N is received. After decoding, the first sample S IN of block N will be in the SRC buffer on position 31 (for the example shown; F=30). Since the SRC reads blocks of 60 samples (in the nominal case if no correction is needed), sample S1N will be located in the middle of DAC 1 buffer N. This sample will be sent to the DAC in the period following DAC interrupt N+1. It can be seen that the time difference Tleave between sample S1N leaving SRC buffer 102 and the sample S1N being sent to digital/analog converter 522 can be calculated by dividing the number of samples F in SRC buffer 102 by the output clock rate Clk_2.

Therefore the RX delay can be calculated as follows:
RX delay=Tarrival+Tdecode+Tleave [eq 3]
Or RX delay=4*W/Clk_{—}1+60/Clk_{—}2+F/Clk_{—}2 [eq 4]

Therefore, a constant RX delay can be achieved if following rule is satisfied:
4*W+F=DR (Delay reference)=constant [eq 5]

The factor 4 in the numerical example is the ratio of 60 to 12 data units and three sync units.

As a result, if W changes by 1 unit, it should be corrected by changing F in the other direction by 4 units. This can be done by reading 56 or 64 samples instead of 60 samples from the SRC buffer.

For the example shown in FIG. 11, DR=58. In the nominal case (no correction need), the number of samples to be read by the SRC is equal to the number of samples to be written to the DAC buffer (60). In the left part of FIG. 11 such a nominal condition is represented by W=6 and F=94. If Clk_2 is running slower than Clk_1 this will be detected at a given moment by reading a value W=7 instead of W=6. This results from DAC interrupt N−1 being delayed by an amount δT with δT=4/Clk_. This deviation will be detected by the buffer management system ([eq 3]) and result in a reading of 64 samples by the SRC block. The will lead to a new steady state condition wit W=7 and F=90, as shown at the right side of FIG. 11. It can be noted that these figures satisfy [eq 5] so that no correction is needed anymore and again 60 samples can be read from the SRC buffer.

It can be seen that the proposed buffer management system provides in this way a nearly constant RX delay. There can be some jitter δT on it, with δT mainly caused by the accuracy of the Tarrival measurement. If Tarrival is jittery (which can be the case if the data blocks enter the RX buffer block-wise and not monotonously), some additional low-pass filtering or other means can be used to reduce the jitter on Rx delay. It should be clear that this mechanism allows obtaining a stable phase relation between the audio signals coming out of loudspeakers 1113 and 1123, with a time jitter between both signals of only a few audio samples.

Under computer program product should be understood any physical realization of a collection of commands enabling a processor—generic or special purpose—, after a series of loading steps to get the commands into the processor, to execute any of the characteristic functions of an invention. In particular the computer program product may be realized as data on a carrier such as e.g. a disk or tape, data present in a memory, data traveling over a network connection—wired or wireless—, or program code on paper. Apart from program code, characteristic data required for the program may also be embodied as a computer program product.

It should be noted that the above-mentioned embodiments illustrate rather than limit the invention. Apart from combinations of elements of the invention as combined in the claims, other combinations of the elements are possible. Any combination of elements can be realized in a single dedicated element.

Any reference sign between parentheses in the claim is not intended for limiting the claim. The word “comprising ” does not exclude the presence of elements or aspects not listed in a claim. The word “a” or “an” preceding an element does not exclude the presence of a plurality of such elements.

The invention can be implemented by means of hardware or by means of software running on a processor.

1. Buffer management system (100) for controlling in a data communication system a delay (Δ) of a data unit (150) between input in the buffer management system (100) and output from the buffer management system (100), comprising:
a buffer (102), in which blocks (104, 106) of inputted data units (150, 152) are written with a block write rate (Rw), and from which data units (154, 156) are read with a read rate (Rr);
a buffer filling measurement component (110) arranged to determine an amount (F) of data units in the buffer (102) at a specified time instant (T1), and yielding a filling measurement (mF); and
a data rate conversion component (108), arranged to set a ratio of the read rate (Rr) and the write rate (Rw), on the basis of the filling measurement (mF); characterized in that
an input time measuring component (112) is comprised, arranged to measure an input time instant (Ta) of input of the data unit (150) in the buffer management system (100), and yielding an input time measurement (mTa); and
a delay control component (120) is comprised for controlling the delay (Δ) by controlling the data rate conversion component (108) on the basis of the filling measurement (mF) and the input time measurement (mTa).

2. Buffer management system (100) as claimed in claim 1, comprising a read time measuring component (160), arranged to measure a read time instant (Tr) of a first data unit (154), and yielding a read time measurement (mTr), and in which buffer management system (100) the delay control component (120) is arranged to control the data rate conversion component (108) on the basis of the read time measurement (mTr).

3. Buffer management system (100) as claimed in claim 1, in which the data rate conversion component (108) comprises a voltage controlled oscillator.

4. Buffer management system (100) as claimed in claim 1, in which the data rate conversion component (108) comprises a sample rate converter (514), arranged to produce a second number of samples (142) out of a first number of samples (140).

5. Buffer management system (100) as claimed in claim 1, comprising a decompressor (512), in which buffer management system the delay control component (120) is arranged to control the data rate conversion component (108) on the basis of a decompression delay associated with the decoder and/or an amount (W) of data units are in a second buffer (506).

6. Digital audio receiver (500) comprising:
a radio reception component (502) with an output (503) connected to
a buffer management system (100) as in claim 1.

7. Headphones (530) comprising a digital audio receiver (500) as claimed in claim 6, an output of the digital audio receiver (500) being connected to a loudspeaker of the headphones.

8. Stand-alone surround sound loudspeaker cabinet (540) comprising a digital audio receiver (500) as claimed in claim 6, an output of the digital audio receiver (500) being connected to a loudspeaker (528) in the cabinet.

9. Method of controlling in a data communication system a delay (Δ) of a data unit (150), between input in a digital audio receiver (500) and output from the digital audio receiver (500), comprising:
Writing blocks (104, 106) of inputted data units (150, 152) in a buffer (102) with a block write rate (Rw);
Determining a filling measurement (mF) of an amount (F) of data units in the buffer (102) at a specified time instant (T1);
Setting a ratio of a read rate (Rr) and the write rate (Rw), on the basis of the filling measurement (mF); and
Reading data units (154, 156) from the buffer (102) with the read rate (Rr), the method being characterized in that:
an input time measurement (mTa) of an input time instant (Ta) of input of the data unit (150) in the digital audio receiver (500) is performed; and
the delay (Δ) is controlled by setting the ratio of the read rate (Rr) and the write rate (Rw) also on the basis of the input time measurement (mTa).

10. Computer program product enabling a processor to execute the method of claim 9.
